(19) United States
(12) Patent Application Publication
(10) Pub. No.: US 2026/0192552 A1
(43) Pub. Date: Jul. 9, 2026

(54) DECORATIVE SURFACE COVERING COMPRISING CARBON-BASED POROUS FILLER DISPERSED IN POLYMER MATRIX

(71) Applicant: TARKETT GDL, LENTZWEILER (LU)

(72) Inventors: Guillaume CHATTE, Wiltz (LU); Carlos Eloy FEDERICO, Wiltz (LU)

(21) Appl. No.: 19/129,331

(22) PCT Filed: Nov. 16, 2023
(86) PCT No.: PCT/EP2023/082120

§ 371 Date: May 13, 2025

(30) Foreign Application Priority Data
Nov. 17, 2022 (LU) LU503080

(51) Int. Cl. B32B 27/20; B32B 3/06; B32B 5/18; B32B 27/30; B32B 27/32; B32B 37/15; B32B 38/00

(52) U.S. Cl. CPC B32B 27/20; B32B 3/06; B32B 5/18; B32B 27/304; B32B 27/32; B32B 37/153; B32B 38/145; B32B 2264/108; B32B 2264/2031; B32B 2264/303; B32B 2264/307; B32B 2305/022; B32B 2305/30; B32B 2307/7375; B32B 2323/10; B32B 2327/06; B32B 2451/00

(57) ABSTRACT

Carbon-based porous filler (CPF) is proposed for incorporation into thermoplastic material, e.g., of a decorative surface covering. It has been recognized that CPF with a carbon content of at least 70% of the CPF dry weight and a specific surface area of 5 to 500 m²/g measured in accordance with standard ISO 9277:2010 (Brunauer-Emmett-Teller (BET) method) may confer advantageous mechanical properties on the thermoplastic material, in particular reduced density (compared to conventional fillers) and higher than expected specific stiffness.

### TECHNICAL FIELD

The disclosure generally relates to decorative surface coverings, such as, e.g., floor coverings (flooring), wallcoverings or ceiling coverings. The disclosure more specifically relates to a core layer of a decorative surface covering comprising a carbon-based porous filler (CPF) dispersed in a matrix of thermoplastic polymers and, optionally, additives (such as, e.g., processing aids, lubricants, compatibilizers, etc.)

### BACKGROUND

Synthetic decorative surface coverings are, to a large extent, petroleum-based, i.e., the polymers they contain are obtained from hydrocarbons sourced from fossil fuels. Efforts have been made to reduce the environmental footprint of surface coverings by increasing the ratio of renewable to non-renewable materials. For instance, natural fiber plastic composites (NFPCs) are composite materials comprised of a polymer matrix embedded with natural fibers, such as, e.g., biomass fibers, like bamboo fibers, hemp fibers, flax fibers, wood fibers, etc. A subgroup of the NFPCs are the wood-plastic composites (WPCs), comprising wood fiber and plastic. NFPCs are considered to suffer from ineffective stress transfer between the polymer matrix and the natural fibers.

U.S. Pat. No. 10,920,370 proposes floor coverings including an upper wear layer and a backing layer, wherein the backing layer includes concentrated carbon as a filler. The floor coverings are praised as having a negative carbon footprint when subjected to a Life Cycle Assessment.

U.S. Pat. No. 10,414,880 discloses carbonized biomass as an alternative to carbon black in the production of synthetic plastics. Carbon black is derived from non-renewable resources such as natural gas or petroleum-derived heavy oils through chemical-thermal conversion. The document more specifically relates to a masterbatch to produce composites, the masterbatch comprising a blend of carbonized biomass and a carrier resin. The carbonized biomass has a particle size lower than about 100 microns, the concentration of the carbonized biomass in the masterbatch is from about 25% wt. to about 75% wt., and the concentration of the carrier resin in the masterbatch is from about 25% wt. to about 75% wt.

### BRIEF SUMMARY

According to a general aspect of the disclosure, carbon-based porous filler (CPF) is proposed for incorporation into thermoplastic material, e.g., of a decorative surface covering. It has been recognized that CPF with a carbon content of at least 70% of the CPF dry weight and a specific surface area (SSA) of 5 to 500 m²/g, preferably of 40 to 500 m²/g, measured in accordance with standard ISO 9277:2010 (Brunauer-Emmett-Teller (BET) method) may confer advantageous mechanical properties on the thermoplastic material, in particular reduced density (compared to conventional fillers) and higher than expected specific stiffness and stress at rupture.

The benefits of CPF were confirmed, in particular, in rigid Luxury Vinyl Tile (LVT) flooring, at a pilot scale by testing thermoplastic materials with different volume fractions of CPF. The testing of thermoplastic materials included 3-point bending tests, dynamic mechanical analysis (DMA), and thermal dilatation testing. Results revealed that increasing the volume fraction of CPF increases the stress at rupture whilst lightening the thermoplastic material (in comparison to CaCO₃-filled thermoplastics). DMA results revealed that the presence of CPF decreased the polymer chain mobility, indicating a better polymer-filler interaction. It may be worthwhile noting that benefits from CPF may be obtained when using CPF as the sole filler or in combination with other fillers, e.g., mineral fillers, like calcium carbonate, talc, chalk, etc.

According to an aspect of the disclosure, decorative surface covering, e.g., a floor covering, a wallcovering, or a ceiling covering, comprises a structural core layer, the core layer comprising a thermoplastic material including one or more thermoplastic polymers as a matrix and a CPF dispersed in the matrix. The CPF has a carbon content of at least 70%, preferably at least 75%, more preferably at least 80%, of the CPF dry weight and a specific surface area of 5 to 500 m²/g, preferably of 20 to 450 m²/g, and more preferably of 40 to 400 m²/g, measured in accordance with standard ISO 9277:2010 (Brunauer-Emmett-Teller (BET) method).

The CPF may have an isotopic ratio ¹⁴C/¹²C of at least 10⁻¹², preferably an isotopic ratio ¹⁴C/¹²C of at least 1.2·10⁻¹². It may be appreciated that ¹⁴C is (essentially) absent in fossil fuels, which have been stored in geological reservoirs for millions of years, i.e., orders of magnitude longer than the radioactive decay time of ¹⁴C (half-life of 5730±40 years). The isotopic ratio thus translates the ratio of carbon sourced from renewable sources (hereinafter: biocarbon) to total carbon, including carbon derived from petroleum (“petrocarbon”) and biocarbon. An isotopic ratio ¹⁴C/¹²C (¹⁴C/¹²C ratio) of at least 10⁻¹² reflects a biocarbon content from about 80 to 100% by weight of total carbon. An isotopic ratio ¹⁴C/¹²C of 1.2·10⁻¹² or more indicates a biocarbon content close to 100% of total carbon. Preferably, the thermoplastic material as a whole (i.e., taking into account the carbon content of the polymer resin, any other fillers, and any additives) has a biocarbon/total carbon ratio of at least 25% by weight (corresponding to an isotopic ratio ¹⁴C/¹²C of at least 2.5.10⁻¹³), more preferably of at least 40% by weight (corresponding to an isotopic ratio ¹⁴C/¹²C of at least 4.10⁻¹³).

According to a preferred embodiment of the disclosure, the CPF comprises or consists of biochar (with the proviso that the biochar meets the above requirements set forth for the CPF). Biochar designates a solid material, rich in carbon, obtained by pyrolysis of biomass (i.e., by thermal decomposition of biomass in an oxygen-poor or oxygen-free environment) or by thermo-catalytic depolymerization of biomass.

The thermoplastic material may comprise one or more additional fillers dispersed therein. The additional filler could be selected among, e.g.: ground limestone, dolomite, (precipitated) calcium carbonate, zeolite, magnesium carbonate, chalk, phyllosilicate, glass particles (e.g., glass fibers or flakes) and aluminum trihydroxide. Lamellar or fibrous fillers may be used to advantageously modify the mechanical properties of the thermoplastic material, e.g., the thermal expansion coefficient. Fibrous fillers usable in the context of embodiments of the disclosure may include glass fibers, or biomass fibers, like bamboo fibers, hemp fibers, flax fibers, wood fibers, etc., preferably delignified cellulosic fibers. Particularly preferred fillers may include inorganic lamellar fillers, such as, e.g., sheet silicate (in particular, talc or mica), clay, montmorillonite, glass flake, and lamellar double hydroxide. The term “sheet silicate” refers to minerals from the group of silicates wherein the silicate anions are usually arranged in layers, e.g., phyllosilicates. By way of example, phyllosilicates may include minerals from the mica group, the chlorite group, the kaolinite group, and the serpentine group.

The thermoplastic material may, preferably, comprise from 2 to 70% by weight, more preferably from 3 to 60% by weight, and still more preferably from 5 to 40% by weight, of the CPF.

The thermoplastic material may have an overall filler content from 5 to 70% by weight, preferably from 10 to 60% by weight. CPF preferably represents at least 30% by weight, more preferably at least 40% by weight, still more preferably at least 50% by weight, yet more preferably at least 60% by weight, yet still more preferably at least 70% by weight, most preferably at least 80% by weight, and uttermost preferably at least 90% by weight, of the overall filler content.

The CPF preferably has a D50 (median) diameter in the range from 1 μm to 50000 μm, more preferably from 2 μm to 5000 μm, yet more preferably in the range from 5 μm to 1000 μm, still more preferably in the range from 15 μm to 500 μm and most preferably from 30 μm to 100 μm. In the context of the present document, the D50 value means the D50 value obtained from the largest Feret diameter measured from images analyzed in accordance with standard ISO 13322-2:2021 (using dynamic image analysis). According to other embodiments, the CPF preferably has a D50 (median) diameter in the range from 1 μm to 1000 μm, more preferably from 10 μm to 200 μm, yet more preferably in the range from 15 μm to 150 μm, and still more preferably in the range from 20 μm to 100 μm. Additionally, the CPF may have a D10 diameter in the range from 1 μm to 1000 μm, preferably in the range from 4 μm to 100 μm, more preferably in the range from 10 μm to 50 μm, and still more preferably in the range from 20 μm to 40 μm. Alternatively, the D10 diameter may be in the range from 5 μm to 100 μm, more preferably in the range from 10 μm to 50 μm, and still more preferably in the range from 10 μm to 40 μm. The CPF may have a D90 diameter in the range from 100 μm to 80000 μm, preferably in the range from 150 μm to 50000 μm, more preferably in the range from 200 μm to 2000 μm, still more preferably in the range from 300 μm to 1000 μm. Alternatively, the CPF may have a D90 diameter in the range from 100 μm to 3000 μm, more preferably in the range from 120 μm to 2000 μm, still more preferably in the range from 120 μm to 1000 μm, yet more preferably in the range from 200 μm to 1000 μm.

The CPF may preferably comprise particles anchored in the thermoplastic polymer matrix by mechanical and/or chemical interlocking caused by thermoplastic polymer having penetrated the pores of the particles. Polymer penetrated into, at least partially filling pores of the CPF leads to strong adhesion between the filler and the polymer matrix by mechanical interlocking. The pores also provide an increased surface area on which adsorption and/or chemical bonding between the polymer and the CPF can occur. This contributes to good stress transfer between the components of the thermoplastic material and eventually results in higher specific stiffness.

The CPF may, advantageously, comprise particles with multidirectional porosity, i.e., with first pores extending in a first direction and second pores extending in a second, transversal, direction. The effect of mechanical interlocking may thus be enhanced.

According to embodiments, the CPF may have pores with diameters in the range from 0.5 μm to 30 μm, preferably in the range from 1 μm to 20 μm, more preferably in the range from 1 μm to 10 μm.

The decorative surface covering may comprise or be a surface covering tile, e.g., a flooring tile, a wallcovering tile, or ceiling covering tile, comprising a décor layer, a wear layer, and, optionally, a backing layer.

The décor layer may comprise a printing substrate carrying a print, the printing substrate having a hiding power H₁₀ (opacity) of at least 80%, preferably at least 90%, measured in accordance with standard ISO 6504-3:2019 (method A). The hiding power of the printing substrate may be obtained by a Spectro-guide 45/0 gloss device in accordance with standard ISO 6504-3:2019. The decorative print itself may comprise a digital print or a print generated by an analogous printing technique such as, e.g., rotogravure, photogravure, offset printing, or the like.

The wear layer may be transparent or translucent. The wear layer may optionally comprise or consist of a crosslinked topcoat (e.g., comprising epoxy, polyurethane, polyurethane acrylate, polyester polyurethane acrylate, polyurethane methacrylate and/or polyester polyurethane methacrylate). The décor layer and/or the wear layer may, optionally, comprise an embossed pattern in register with the decorative print of the décor layer. The wear layer and/or the topcoat could each comprise or be built from one or plural layers. These could be distinguishable from each other in the final product or not. The embossed pattern could be the result of mechanical embossing (with an embossed cylinder or plate) or three-dimensional digital printing.

The core layer may comprise or consist of a stiff core layer possessing a deformation angle of less than 7 degrees, more preferably of less than 5 degrees, most preferably of less than 3 degrees, as measured by the following deformation test (cantilever test) carried out in ambient conditions of temperature and pressure (at 23° C. and at atmospheric pressure, i.e., about 1000 hPa). According to the deformation test, a rectangular sample (in this case of the core layer) with dimensions of 160 mm×450 mm, is clamped in a horizontal cantilevered position to obtain a 160×300 mm projecting part of the sample. The projecting portion is initially supported over its entire length and width by a removable horizontal support. The deformation angle is measured 30 seconds after the removal of the support that prevents the deformation of the projecting part under the influence of its own weight. The deformation angle is a measure of the flexural strength of the structure being tested.

According to a preferred embodiment, the decorative surface covering may comprise or consist of a flooring tile, the flooring tile comprising a first locking connector along a first edge, a second locking connector along a second edge (opposite to the first edge), the first and second locking connectors being complementarily profiled, so that the flooring tile can be interlocked with another flooring tile by engaging the first or the second locking connector of the flooring tile with the second or first locking connector, respectively, of the other flooring tile. Optionally, the flooring tile may further comprise a third locking connector along a third edge, a fourth locking connector along a fourth edge (opposite to the third edge), the third and fourth locking connectors being complementarily profiled, so that the flooring tile can be interlocked with another flooring tile by engaging the third or the fourth locking connector of the flooring tile with the fourth or third locking connector, respectively, of the other flooring tile. The first and third locking connectors may be of identical shape, in which case, the second and fourth locking connectors may advantageously also be identically shaped, complementarily to the first and third locking connectors. Alternatively, the first and third locking connectors may be of different shapes, and the second and fourth locking connectors may thus also be of different shapes.

The thermoplastic material includes one or more thermoplastic polymers as a matrix embedded with the CPF and any other additional filler. Thermoplastic polymers may include, for example: polyacrylic acid, polyacrylate, polyamide (PA), polyester, polylactic acid (PLA), polycarbonate (PC), polyether sulfone (PES), polyether ether ketone (PEEK), polyvinyl butyral (PVB), polyetherimide (PEI), polyethylene, polypropylene (PP), polystyrene, polyvinyl chloride (PVC), polyvinylidene fluoride (PVDF), acrylonitrile butadiene styrene (ABS), thermoplastic cellulose esters, etc. According to particularly preferred embodiments, the one or more thermoplastic polymers of the thermoplastic material may include polyvinyl chloride or polyvinyl butyral, preferably recycled polyvinyl chloride and/or recycled polyvinyl butyral.

According to a particularly preferred embodiment of the disclosure, the decorative surface covering is (essentially) PVC-free.

The thermoplastic material may comprise a plural species of thermoplastic polymers. In this case, it may be preferred that one or at most two polymer species are dominant in the sense that it or they represent at least 85% by weight of the overall thermoplastic polymer content (85 phr) of the thermoplastic material. Further species of thermoplastic polymers may, preferably, represent at most 15% by weight of the thermoplastic polymer content of the thermoplastic material.

According to a specific embodiment, the decorative surface covering comprises a core layer, the core layer comprising a thermoplastic material including one or more thermoplastic polymers as a matrix, the one or more thermoplastic polymers including polyvinyl chloride, polypropylene or polyvinyl butyral, preferably recycled polyvinyl chloride, polypropylene or polyvinyl butyral, and an additional filler selected among: calcium carbonate, and/or phyllosilicate, e.g., talc or clay.

According to a particularly preferred embodiment of the disclosure, the decorative surface covering comprises a core layer, the core layer comprising a thermoplastic material including one or more thermoplastic polymers as a matrix, the one or more thermoplastic polymers comprising polypropylene and an additional filler which is: calcium carbonate and/or talc.

In an aspect, the present disclosure also refers to a process for manufacturing a core layer of the decorative surface covering comprising the steps:
1) mixing a thermoplastic material including one or more thermoplastic polymers and a carbon-based porous filler (CPF) at a peripherical speed from 5 m·s⁻¹ to 85 m·s⁻¹ until the mixture of thermoplastic material and CPF reaches a temperature from 95° to 125° C., and
2) extruding the mixture of thermoplastic material and CPF at a temperature of at least 100° C. by using at least one screw that rotates at a local maximum shear rate from 50s⁻¹ to 400 s⁻¹.

The process allows reducing the size of the CPF particles and/or decreasing the intrinsic moisture of the CPF. The reduction of the CPF particle size leads to an improved dispersion of the CPF in the thermoplastic material and to an increase of the mechanical effect of the CPF.

It is thus possible to use CPF particles having D50 diameter which is superior to 50000 μm for manufacturing a core layer for use in the decorative surface covering according to the disclosure. The implementation of the process allows the use of a wider range of CPF granulometries. Both steps 1 and 2 may be combined in order to optimize the CPF properties as to the particle size and the moisture content. Steps 1 and 2 may be performed one time or several times. Step 1 of the process leads to obtaining CPF particles having a D50 diameter inferior to 50000 μm. Step 1 of the process may be performed in a high-speed mixer. Step 1 of the process may, preferably, be conducted at a temperature from 100° C. to 120° C. and more preferably at a temperature from 105° C. to 115° C. Step 2 of the process allows decreasing the moisture content of the core layer by a factor from 2 to 5. Step 2 of the process may be performed with a single-screw or a twin-screw extruder, and/or the use of continuous kneader technology. At the end of step 2, the moisture content of the resulting core layer may be decreased by 90% wt of the initial moisture content of the mixture of thermoplastic material and CPF filler.

According to embodiments of the disclosure, the core layer may comprise a core layer assembly including at least two layers of different constitutions, e.g., comprising or consisting of different thermoplastic materials. The core layer assembly could, e.g., include three or more layers, including two outer layers sandwiching one or more inner layers. The two outer layers could be unfoamed layers comprised of the thermoplastic material. The one or more inner layers may comprise at least one foamed layer, the foamed layer optionally comprising the thermoplastic material or another thermoplastic material including one or more thermoplastic polymers as a matrix and a CPF dispersed in the matrix, the CPF preferably having a carbon content of at least 70%, of the dry weight and a specific surface area of 5 to 500 m²/g, preferably of 40 to 500 m²/g, measured in accordance with standard ISO 9277:2010.

According to an embodiment, the core layer, when comprising a core layer assembly, may be prepared by a calendaring process. More specifically, at least two individual layers having a thickness comprised in the range from 0.05 mm to 2.5 mm can be calendared at roller temperatures from 120° C. to 220° C. at a speed from 1 meter/minute to 100 meter/minute. The at least two individual layers may also be calendared together with at least one reinforcing layer (such as, e.g., a glass veil or glass grid), at least one décor layer and at least one wear layer to obtain a decorative surface covering having a thickness comprised in the range from 1 mm to 5 mm.

According to another embodiment, the core layer may be obtained by agglomeration of pellets. In the context of the disclosure, the pellets comprise thermoplastic material including one or more thermoplastic polymers as a matrix and a CPF dispersed in the matrix and at least one filler. In this case, the core layer may be obtained by compaction of the pellets at a temperature from 160° C. to 220° C., and preferably at a pressure from 1 bar to 20 bar.

According to a particularly preferred embodiment, the decorative surface covering is or comprises a surface covering tile, e.g., a floor covering, a wallcovering or a ceiling covering, comprising a décor layer, a wear layer and a stiff core layer (serving as a structural support of the décor layer and the wear layer) that includes a thermoplastic material including one or more thermoplastic polymers as a matrix and a CPF dispersed in the matrix, the CPF having a carbon content of at least 70%, preferably at least 75%, more preferably at least 80%, of the dry weight and a specific surface area of 5 to 500 m²/g, preferably of 40 to 500 m²/g, measured in accordance with standard ISO 9277:2010, CPF having an isotopic ratio ¹⁴C/¹²C of at least 10⁻¹² preferably an isotopic ratio ¹⁴C/¹²C of at least 1.2.10⁻¹², the thermoplastic material comprising from 2 to 70% by weight, preferably from 3 to 60% by weight, more preferably from 5 to 40% by weight, of the CPF, the thermoplastic material having an overall filler content from 5 to 70% by weight, preferably from 10 to 65% by weight, and more preferably from 10 to 60% by weight, the CPF particles having a D50 diameter in the range from 15 μm to 100 μm, preferably in the range from 20 μm to 80 μm, the CPF comprising particles anchored in the thermoplastic polymer matrix by interlocking caused by thermoplastic polymer penetrated into pores of the particles, the CPF comprising particles with multidirectional porosity, i.e., with first pores extending in a first direction and second pores extending in a second, transversal, direction. The core layer is stiff in the sense that it possesses a deformation angle of less than 7 degrees, more preferably of less than 5 degrees, and most preferably of less than 3 degrees, as measured by the deformation test. According to a particularly preferred variant of this embodiment, the thermoplastic material comprises dispersed therein, an additional filler selected among ground limestone, dolomite, calcium carbonate (e.g., precipitated calcium carbonate), zeolite, magnesium carbonate, chalk, phyllosilicate (e.g., talc or clay), glass particles and aluminum trihydroxide. The core layer is preferably a core layer assembly including at least two layers of different constitution. The core layer assembly may, preferably, include three or more layers, including two outer layers sandwiching one or more inner layers. The two outer layers are preferably unfoamed layers comprised of the thermoplastic material, whereas the one or more inner layers may comprise at least one foamed layer, the foamed layer optionally comprising the thermoplastic material or another thermoplastic material including one or more thermoplastic polymers as a matrix and CPF dispersed in the matrix, the CPF having a carbon content of at least 70%, of the dry weight and a specific surface area of 5 to 500 m²/g, preferably of 20 to 450 m²/g, and most preferably of 40 to 400 m²/g, measured in accordance with standard ISO 9277.

As used herein “isotopic ratio” refers to the ratio of the number (moles) of first isotopes of a chemical species to the number (moles) of second isotopes of the chemical species.

Unless contradicted by context, when reference is made herein to the “diameter” of a particle, what is meant is the maximum distance between two parallel planes tangent to the particle that can be measured for that particle. In other words, the diameter of a particle corresponds to the greatest of all Feret diameters that can be measured for the particle. The Feret diameter along a specified direction is defined as the distance between two parallel planes tangent to the particle and orthogonal to the specified direction. The expression “aspect ratio”, as used herein, refers to the ratio between the shortest and the longest Feret diameters of a particle. When the expression “aspect ratio” is used to qualify a set of particles (such as, e.g., a filler), it designates the ratio between the average shortest Feret diameter to the average longest Feret diameter. The D50 diameter designates the median diameter of the particles of a given set, i.e., the value at or below which 50% of the particle diameters in the given set are found. The expressions “D10 diameter” and “D90 diameter” designate the values at or below which 10% and 90%, respectively, of the particle diameters in the given set are found.

Terms such as “up”, down”, “lower”, “upper”, “horizontal”, “vertical”, “above”, “below”, “top” and “bottom” as well as derivatives thereof (e.g., “horizontally”, “upwards”, etc.) refer to the orientation of a surface covering laid with its decorative face oriented upwards. For a flooring tile or flooring, this orientation corresponds to the position of the flooring tile or flooring when in use as intended by the designer, i.e., laid on the floor. The terms referring to the orientation of the surface covering are employed herein for convenience of description and as a naming convention. They shall be construed to refer to the relative orientation of the different parts but are not meant to imply a particular absolute orientation of the tile or flooring component in space. E.g., arranging a tile with its decorative face upside down shall not prevent the decorative face from being considered the top surface.

The qualifier “decorative”, as used herein, is intended to imply that the item thereby qualified, such as the surface covering, remains visible in normal use (as an item of finishing work). The use of the term, should not, however, be taken to imply any particular aesthetic appearance or any particular aesthetic design. The expression “décor layer” designates a layer with a decorative motif. Examples of décor layers include print layers, in particular, rotogravure-printed layers and digitally printed layers.

The expression “surface normal” refers to the direction perpendicular to the surface of the decorative side (the top side) of the surface covering.

As used herein, the expression “thermoplastic material” encompasses plastic polymer material blends that become pliable or moldable at a certain elevated temperature and solidify upon cooling, the solidification being reversible by heating the material again to the elevated temperature. Thermoplastic (polymer) material may comprise thermoplastic polymers and, optionally, one or more plasticizers, (mineral or organic) fillers, and further additives (e.g., impact modifiers, compatibilizers, processing aids). In the context of the present document, two or more initially separate thermoplastic materials that have been intimately blended together have to be considered, in their blended state, as one thermoplastic material. Accordingly, when reference is made herein to a surface covering or any component thereof comprising two or more thermoplastic materials, it is understood that these two or more thermoplastic materials are present in physically separate volumes, e.g., in different layers, in different distinguishable granules, or the like.

In contrast to “thermoplastic”, the expression “crosslinked” qualifies polymer material (such as, e.g., a topcoat) that has been irreversibly hardened through crosslinking between polymer chains so as to generate an infusible and insoluble network of polymer. Crosslinked (polymer) material may include, e.g., one or more thermoset or radiation-cured polymers. Radiation-cured polymers include, in particular, UV-cured and/or electron-beam-cured polymers. Crosslinked (polymer) material may comprise thermoset and/or radiation-cured polymers (e.g., polyurethane, polyimide, epoxy, etc.) and, optionally, one or more plasticizers, (mineral or organic) fillers, and further additives (e.g., impact modifiers, photoinitiators, antioxidants, etc.) or processing aids.

As used herein, the expression “parts” in the context of a composition means parts by weight.

In the present document, the verb “to comprise” and the expression “to be comprised of” are used as open transitional phrases meaning “to include” or “to consist at least of”. Unless otherwise implied by context, the use of singular word form is intended to encompass the plural, except when the cardinal number “one” is used: “one” herein means “exactly one”. Ordinal numbers (“first”, “second”, etc.) are used herein to differentiate between different instances of a generic object; no particular order (in space or in time), importance, hierarchy, or limitation in number is intended to be implied by the use of these expressions. Furthermore, when plural instances of an object are referred to by ordinal numbers, this does not necessarily mean that no other instances of that object are present (unless this follows clearly from context). When this description refers to “an embodiment”, “one embodiment”, “embodiments”, etc., this means that the features of those embodiments can be used in the combination explicitly presented but also that the features can be combined across embodiments without departing from the disclosure, unless it follows from the context that features cannot be combined.

### BRIEF DESCRIPTION OF THE DRAWINGS

By way of example, preferred, non-limiting embodiments of the disclosure will now be described in detail with reference to the accompanying drawings, in which:

FIG. 1: is a cross-sectional schematic view of a surface covering tile according to an embodiment of the disclosure;

FIG. 2: is an illustration of the deformation test, showing the cantilevered sample in the initial supported position; and

FIG. 3: is an illustration of the deformation test, showing the cantilevered sample after removal of the support of the projecting portion;

FIG. 4: is a representation of FT-IR spectra of three different CPFs used in examples discussed hereinafter;

FIG. 5: shows graphs of the specific stiffness as a function of filler content measured (a) on samples with CPF and (b) on comparative samples with calcium carbonate filler;

FIG. 6: depicts the strain at rupture for samples containing different volume fractions of carbon-based porous filler and calcium carbonate, respectively;

FIG. 7: shows the ultimate-stress values determined in 3-point bending tests carried out on samples with CPF and comparative samples;

FIG. 8: shows the evolution of the loss factor, i.e., the ratio between the loss modulus, E″, and the storage modulus, E′, as a function of temperature for thermoplastic materials with different contents in CFP;

FIG. 9: shows the loss factor as a function of the temperature in thermoplastic materials comprising calcium carbonate or CPF, respectively;

FIG. 10: shows Cole-Cole plots of samples with different contents in CFP;

FIG. 11: shows Cole-Cole plots of samples with CFP compared to those of samples with calcium carbonate;

FIG. 12: are SEM images of the fractured surfaces of samples with CPF obtained from the 3-point bending test, showing that the polymer matrix infiltrates the pores of the CPF particles;

FIG. 13: is an SEM image of a CPF particle with pores extending along a first and a second mutually transversal directions;

FIG. 14: illustrates the specific stiffness of thermoplastic materials filled with CPFs of different SSA;

FIG. 15: illustrates the stress at rupture of thermoplastic materials filled with CPFs of different SSA

FIG. 16: illustrates the stress at rupture of thermoplastic materials filled with mixtures of CPF and CaCO₃ in comparison with thermoplastic materials filled with CPF only or CaCO₃ only.

### DETAILED DESCRIPTION

Rigid decorative surface coverings (e.g., LVT) have numerous advantages (easy installation, suitable for renovation including uneven subfloors, water tightness . . . ) The core layer of those products may be quite thick (e.g., 2-8 mm) and often semi-rigid or rigid (stiffness ranging from 0.5-2 GPa and from 2 GPa-10 GPa (or higher) respectively). Often, filled PVC is used as the thermoplastic material of the core layer, but there is also a growing demand for alternatives to PVC (compliance with some local regulations, concerns with PVC in some regions, etc.)

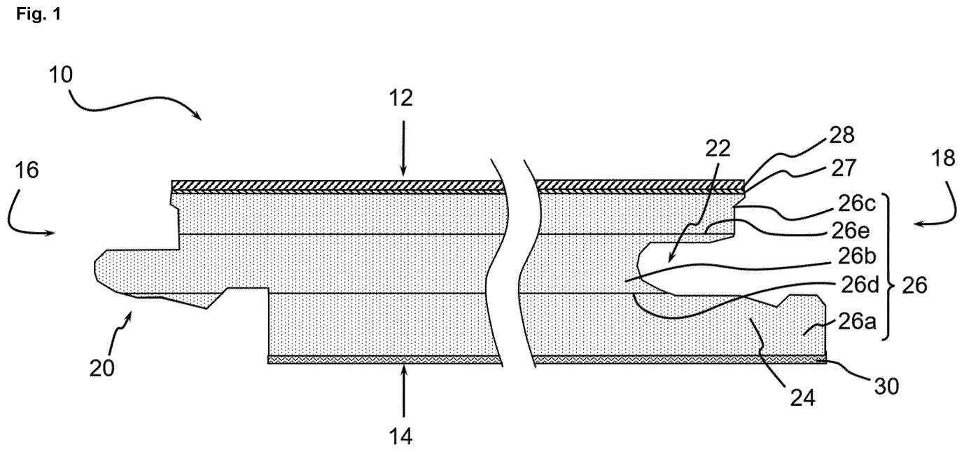

FIG. 1 shows a decorative surface covering tile 10 according to an embodiment of the disclosure. The tile 10 may be, e.g., a rigid luxury vinyl tile (LVT). The tile 10 may have a top surface 12, a bottom surface 14 and at least four side edges. FIG. 1 shows a first edge 16 and a complementarily shaped second edge 18 in more detail. The first edge 16 may comprise a first locking profile featuring a tongue 20 (“male profile”) and the second edge 18 may comprise a second locking profile featuring a groove 22 (“female profile”). The first and second locking profiles may be configured mutually complementarily for mechanically engaging and interlocking with a second and a first connection profile, respectively, of another tile of the same type. Specifically, the tongue 20 and the groove 22 may be complementarily shaped, so as to enable a tongue-and-groove connection between neighboring tiles. The groove 22 may be delimited at its bottom by a base 24.

The tile 10 may be of a layered structure and include a core layer 26, a décor layer 27 and a transparent or translucent wear layer 28 arranged on the core layer 26. The core layer 26 may be rigid. The décor layer 27 may include a printing substrate carrying one or more digitally printed ink layers. The décor layer 27 could, alternatively, be printed directly on the core layer 26. As a further possibility, the décor layer 27 could be printed on the backside of the wear layer 28 before the wear layer 28 and the core layer 26 are laminated so as to sandwich the décor layer 27. A backing layer 30, e.g., a resilient foam layer, a felt layer or a fleece layer, may be arranged on the bottom side 14 of the tile 10.

The core layer 26 may comprise plural sublayers, e.g., one or more thermoplastic layers 26a, 26b, 26c and one or more reinforcing fiber layers 26d, 26e. The one or more fiber layers 26d, 26e may be optional and may comprise veils, grids or textiles made from reinforcing fibers, e.g., glass fibers, aramid fibers, ultra-high-molecular-weight polyethylene (UHMWPE) fibers, or the like. The one or more fiber layers 26d, 26e may be embedded in or adjacent to the one or more thermoplastic layers 26a, 26b, 26c. If the core layer 26 comprises plural thermoplastic sublayers 26a, 26b, 26c, these may be made from thermoplastic materials of the same or two or more different compositions. It may be worthwhile noting, however, that the core layer 26 could, alternatively, comprise the same thermoplastic material throughout its height.

The decorative surface covering tile 10 may have an overall height in the range from 2 to 10 mm, preferably in the range from 2.5 mm to 9 mm, and most preferably in the range from 2.5 mm to 8.5 mm.

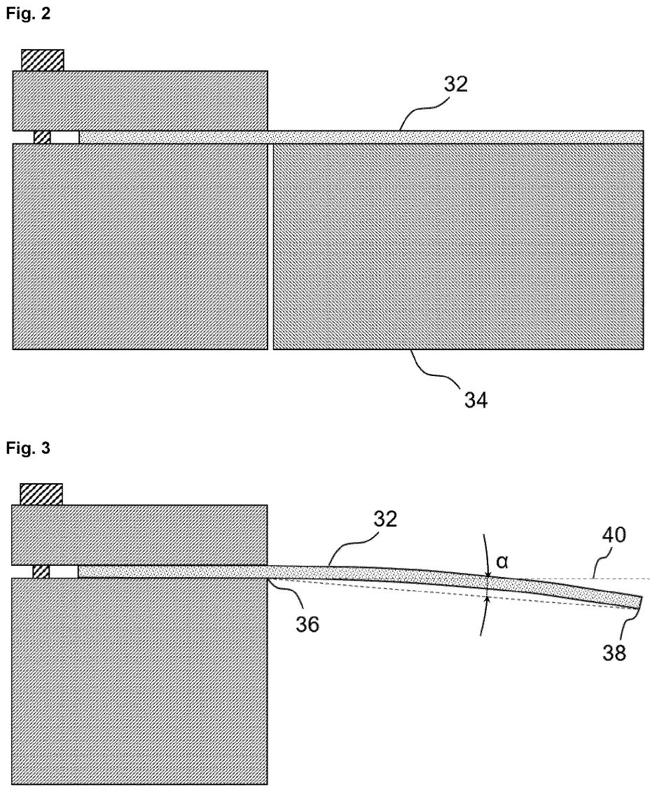

The core layer 26 may possess a deformation angle (α) of less than 10 degrees, preferably of less than 7 degrees, more preferably of less than 5 degrees, and most preferably of less than 3 degrees, as measured by the deformation test. To carry out the deformation test, illustrated in FIGS. 2 and 3, a 160 mm×450 mm rectangular sample 32 of the core layer 26 (including sublayers 26a, 26b, 26c, 26d, 26e in the illustrated embodiment) or of another layer (assembly) is prepared. The sample 32 is then clamped in a horizontal cantilevered position so as to obtain a 160×300 mm rectangular projecting part of the sample. The projecting part is initially supported over its entire length and width by a removable horizontal support. This support is then removed so that the projecting part bends under its own weight. The deformation angle α is measured 30 seconds after removal of the support 34 that prevents the deformation of the projecting part under the influence of its own weight. The deformation angle α corresponds to the angle between the horizontal support plane 40 and the plane extending from the edge 36 of the support from which the projecting portion projects to the lowermost extremity 38 of the projecting portion. The deformation test is carried out at ambient temperature and pressure (at 23° C. and at about 1000 hPa).

The core layer 26 comprises a thermoplastic material including a thermoplastic polymer (e.g., PVC or PVB), filler and additives. The filler comprises or consists of CPF and is dispersed in the thermoplastic polymer. The CPF has a carbon content of at least 70%, preferably at least 75%, more preferably at least 80%, of the CPF dry weight and a specific surface area of 5 to 500 m²/g, preferably of 40 to 500 m²/g, measured in accordance with standard ISO 9277:2010. The CPF may have an isotopic ratio ¹⁴C/¹²C of at least 10⁻¹², preferably an isotopic ratio ¹⁴C/¹²C of at least 1.2.10⁻¹². It follows that the CPF is obtained in major part from renewable carbon sources, e.g., plant biomass. From 80 to 100% by weight of total carbon contained in the CPF is preferably biocarbon. Preferably, the thermoplastic material as a whole (i.e., taking into account the carbon content of the polymer resin, any other fillers, and any additives) has a biocarbon/total carbon ratio of at least 25% by weight (corresponding to an isotopic ratio ¹⁴C/¹²C of at least 2.5·10⁻¹³), more preferably of at least 40% by weight (corresponding to an isotopic ratio ¹⁴C/¹²C of at least 4·10⁻¹³).

The CPF preferably has the following physicochemical properties:
presence of multidirectional pores at least in larger particles, in particular in particles having a diameter larger than the D90 diameter of the filler,
presence of CPF particles having pores with pore diameters in the range from 1 μm-30 μm,
specific surface area (ISO 9277:2010) of the CPF: 5 m²/g to 500 m²/g,
D50 diameter (ISO 13322-2:2021) of the CPF: 1 μm-1000 μm,
aspect ratio: 0.3-0.7 of the CPF,
Carbon content (DIN 51732:2014) of the of the CPF: 80%-95%,
H/C of the CPF (determined by elemental composition analysis of the particles by means of a CHNS analyzer, following standard ASTM E777, 778): 0.1-0.5,
O/C of the CPF (determined by elemental composition analysis of the particles by means of a CHNS analyzer, following standard ASTM E777, 778): 0.01-0.15.

According to a first preferred embodiment, at least one layer of the core layer comprises a thermoplastic material including, per 100 parts of thermoplastic polymer, from 15 to 150 parts of CPF and up to 20 parts of additives (stabilizer(s), lubricant(s), compatibilizer(s), processing aid(s), etc.)

Examples of thermoplastic material compositions according to the first preferred embodiment are detailed in Table 1 below.

TABLE 1

| | Examples | | | | | | |
|---|---|---|---|---|---|---|---|
| Ingredient | EX1 | EX2 | EX3 | EX4 | EX5 | EX6 | EX7 |
| PVC | 100 | 100 | 100 | 100 | 100 | 100 | 100 |
| CPF1 | 20 | 40 | 65 | 80 | 110 | | |
| CPF2 | | | | | | 65 | |
| CPF3 | | | | | | | 65 |
| Stabilizer(s) | 9 | 9 | 9 | 9 | 9 | 9 | 9 |
| Processing aid(s) | 5 | 5 | 5 | 5 | 5 | 5 | 5 |
| Internal & external | 3 | 3 | 3 | 3 | 3 | 3 | 3 |
| lubricant (s) | | | | | | | |

In examples EX1-EX6 and EX7-EX10 (see table 3 below), PVC was suspension PVC from Inovyn with a grain size from 5-200 μm and K value of 67. Stabilizers were one-pack Ca/Zn stabilizers from Reagens. Processing aids were acrylic-based produced by Arkema. External and internal lubricant(s) included polyolefin wax(es) from Wiwax and stearin from Brenntag. CPF1, CPF2 and CPF3 were samples of pyrolyzed biomass from different sources.

The physicochemical properties of CPF1, CPF2 and CPF3 (in dry state) are indicated in Table 2:

TABLE 2

| | CPF sample | | | | | |
|---|---|---|---|---|---|---|
| Property | CPF1 | | CPF2 | | CPF3 | |
| Ash (550° C., DIN | 3.8 | wt. % | 2 | wt. % | 2.6 | wt. % |
| 51719:1997) | | | | | | |
| Carbon (DIN 51732:2014) | 82 | wt. % | 93 | | 92 | |
| Specific surface | 48 | m²/g | 360 | m²/g | 415 | m²/g |
| (BET, ISO 9277:2010) | | | | | | |
| True density | 1.4 | g/cm³ | 1.4 | g/cm³ | 1.4 | g/cm³ |
| (ISO 9277:2010) | | | | | | |
| D50 diameter | 27 | μm | 41 | μm | 57 | μm |
| (ISO 13322-2:2022) | | | | | | |

| | | | |
|---|---|---|---|
| Aspect ratio | 0.63 | 0.63 | 0.59 |
| Isotopic ratio ¹⁴C/¹²C | >10⁻¹² | >10⁻¹² | >10⁻¹² |
| Aromaticity (H/C) | 0.46 | 0.19 | 0.19 |
| Deoxygenation (O/C) | 0.11 | 0.02 | 0.02 |

Particle size and aspect ratio of CPF1-CPF3 were characterized by a CAMSIZER X2 device of Microtrac MRB, based on Dynamic Image Analysis (ISO 13322-2:2021). The CaCO₃ filler used in the comparative examples (CEX1, CEX2, see table 3 below) had a median particle size (D50 diameter) of 5.9 μm, an SSA of 4 m²/g and an aspect ratio of 0.75. These properties were determined with the same analyzer as for the CPFs.

The porosity of the CPF samples was characterized by means of the Brunauer-Emmett-Teller (BET) analysis (DIN 66137/DIN ISO 9277) with nitrogen gas. The method determines the amount of nitrogen adsorption on a surface at a given pressure, which provides a direct value of the specific surface area (SSA). A larger SSA indicates a more prominently porous morphology.

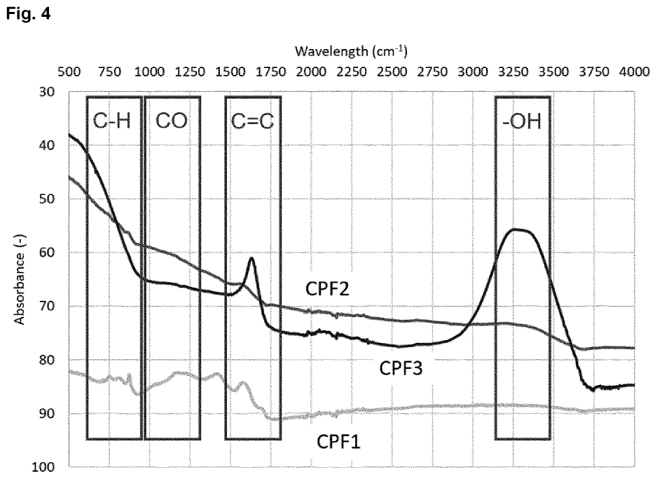

Complementary analysis by Fourier-transform infrared spectroscopy (FT-IR) was performed on the CPF samples to address their surface functional groups. The FT-IR spectra reveal (see FIG. 4) the presence of —OH hydroxyl group (linked to moisture), aromatic rings (C═C) and aliphatic groups (C—H) characteristic of the benzene rings in the carbon structure of the filler and carbonyl group (C═O). The carbon nature and polar groups of the fillers enable hydrogen bonding with the polar structure of PVC.

Scanning electron microscopy (SEM) was used to reveal the porous nature of the CPF samples (see FIG. 13). It was noted that the larger particles had pores extending along a first and a second direction, the second direction being transversal to the first direction (see arrows in FIG. 13). Pores diameters were in the range from 1 μm-30 μm. The CPF samples with higher SSA contained more numerous pores.

According to a second preferred embodiment, at least one layer of the core layer comprises a thermoplastic material including, per 100 parts of thermoplastic polymer, from 15 to 100 parts of CPF as a first filler, from 15 to 100 parts of one or more additional, mineral, fillers and up to 20 parts of additives.

Examples of thermoplastic material compositions according to the second preferred embodiment, as well as comparative examples, are detailed in Table 3 below.

TABLE 3

| | Examples | | | | | | |
|---|---|---|---|---|---|---|---|
| Ingredient | EX8 | EX9 | EX10 | EX11 | CEX1 | CEX2 | CEX3 |
| PVC | 100 | 100 | 100 | | 100 | 100 | |
| PP | | | | 100 | | | 100 |
| CPF1 | 80 | 40 | 80 | 50 | | | |
| CaCO₃ | 40 | 80 | 80 | 50 | 130 | 160 | 147 |
| Talc | | | | 87 | | | 83 |
| Stabilizer(s) | 9 | 9 | 9 | 0.25 | 9 | 9 | 0.25 |
| Processing | 5 | 5 | 5 | | 5 | 5 | |
| aid(s) | | | | | | | |
| Internal & | 3 | 3 | 3 | 3 | 3 | 3 | 3 |
| external | | | | | | | |
| lubricant (s) | | | | | | | |
| Coupling | | | | 5 | | | 5 |
| agent | | | | | | | |

In examples EX11 and CEX3, the polypropylene (PP) part was a mix (50/50) of Moplen (trademark) EP300M & Moplen (trademark) EH400H from LyonDellBasell. The coupling agent was Licocene (trademark) PP MA 7452 from Clariant. Talc was Luzenac (Trademark) ST30 from Imerys. The lubricant package included stearic acid and glycerol esters (for example Loxiol (trademark) EP55 from EmeryOleochemicals). The stabilizer package included blends of Irganox (trademark) 1010 from BASE and Irgafos (trademark) 168 from BASE. Example EX11 and CEX3 were prepared to maintain the volume fraction (vol %) of the filler.

The different thermoplastic composite materials of examples EX1-EX10 and of comparative examples CEX, CEX2 were obtained by first dry blending the ingredients (see Tables 1 and 3) at 115±500 during 10±2 min, and then extruding the mixed product by a counter-rotative twin (parallel screws) extrusion process in an extruder equipped with a vacuum pump to extract the intrinsic humidity of the CPF. The processing conditions included a rotation speed of 120±20 rpm (rotations per minute) and a processing temperature of 190±1000. The thermoplastic composite materials of examples EX11 and comparative example CEX3 were extruded in a twin-screw corotating extruder equipped with a vacuum pump to extract the intrinsic humidity of the CPF filler. The melt temperature was around 21000.

Table 4 hereinbelow indicates the volume fractions of the filler(s) in the different examples and the comparative examples:

TABLE 4

| | Volume of filler/total volume of thermoplastic material | | |
|---|---|---|---|
| Example | CPF | CaCO₃ | Talc |
| EX1 | 15% (v/v) | | |
| EX2 | 25% (v/v) | | |
| EX3 | 35% (v/v) | | |
| EX4 | 40% (v/v) | | |
| EX5 | 50% (v/v) | | |
| EX6 | 35% (v/v) | | |
| EX7 | 35% (v/v) | | |
| EX8 | 35% (v/v) | 10% (v/v) | |
| EX9 | 20% (v/v) | 20% (v/v) | |
| EX10 | 35% (v/v) | 15% (v/v) | |
| EX11 | 18% (v/v) | 9% (v/v) | 14% (v/v) |
| CEX1 | | 35% (v/v) | |
| CEX2 | | 40% (v/v) | |
| CEX3 | | 27% (v/v) | 14% (v/v) |

Due to the low density of the CPF (1.35 g/cm³-1.4 g/cm³), the total density of thermoplastic materials containing CPF as a filler is decreased when compared to standard CaCO₃-filled thermoplastic materials having about the same volume fraction of filler.

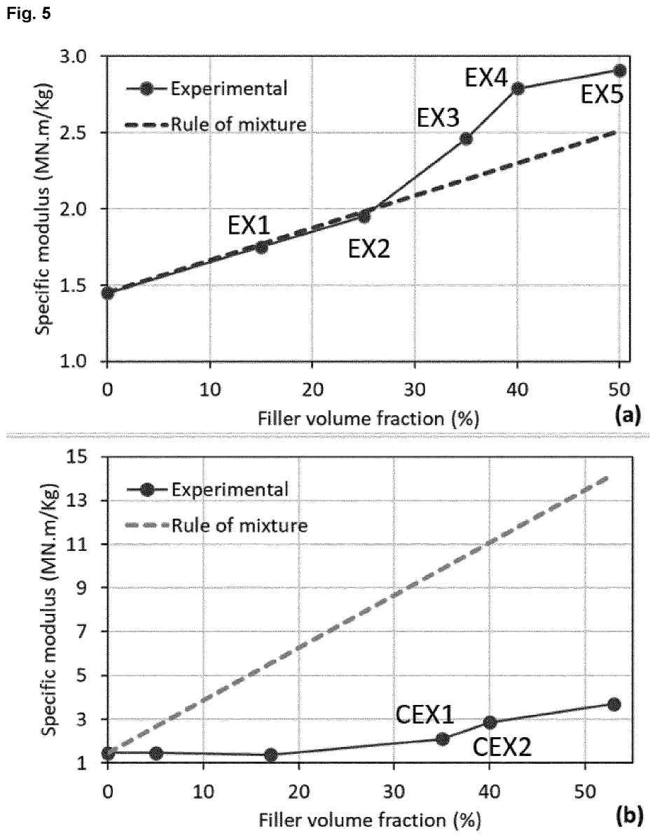

Thermoplastic materials with different volume fractions of fillers were tested by 3-point bending measurements. The first parameter to be evaluated was the stiffness-to-weight ratio or specific stiffness, which is a relevant parameter to classify optimal structures with minimum weight and low deflection. Results are depicted in FIGS. 5 (a) and (b). For both fillers, an increase in the specific stiffness with the volume fraction of filler is observed. An attempt to describe such an increase is carried out by means of a rule of mixture:

$${E}_{c} / {ρ}_{c} = {ϕ}_{f} {E}_{f} / {ρ}_{f} + ( 1 - {ϕ}_{f} ) {E}_{m} / {ρ}_{m} , \qquad ( Eq . 1 )$$

where φ_{f} is the volume fraction of filler, ρ_{c}, ρ_{f} and ρₘ are the densities of the thermoplastic material (composite), filler, and matrix (polymer resin), respectively, and E_{c}, E_{f} and Eₘ are the stiffness of the thermoplastic material (composite), filler and matrix (polymer resin), respectively. For the sake of illustration, the moduli of a PVC matrix, a CPF, and a CaCO₃ filler may assumed to be 2.1 GPa, 5 GPa, and 68 GPa, respectively. For the rule of mixture to be accurate, three hypotheses need to be fulfilled:
i) Rigid (non-deformable) fillers,
ii) uniform dispersion and distribution of fillers and,
iii) perfect polymer-filler adhesion.

When observing the results in FIG. 5 (a) for the thermoplastic materials containing CPF, the rule of mixture exhibits a good agreement with the experimental data up to 25 vol. % of filler. Above this level, the experimental values of the specific stiffness are higher than those predicted by the rule of mixture. This may be an indication that a good polymer-filler interaction/adhesion exists and an interphase (i.e., a thin (e.g., about 0.1 to about 1.0 μm) region between the filler surface and the bulk polymer matrix with mechanical properties different from those of the bulk polymer) is created. For the CaCO₃-filled thermoplastic material, FIG. 5 (b) shows that the rule of mixture overestimates the specific stiffness when compared to the experimental data. This is likely due to a poor filler distribution and to an inexistent or poor polymer-filler interaction/adhesion.

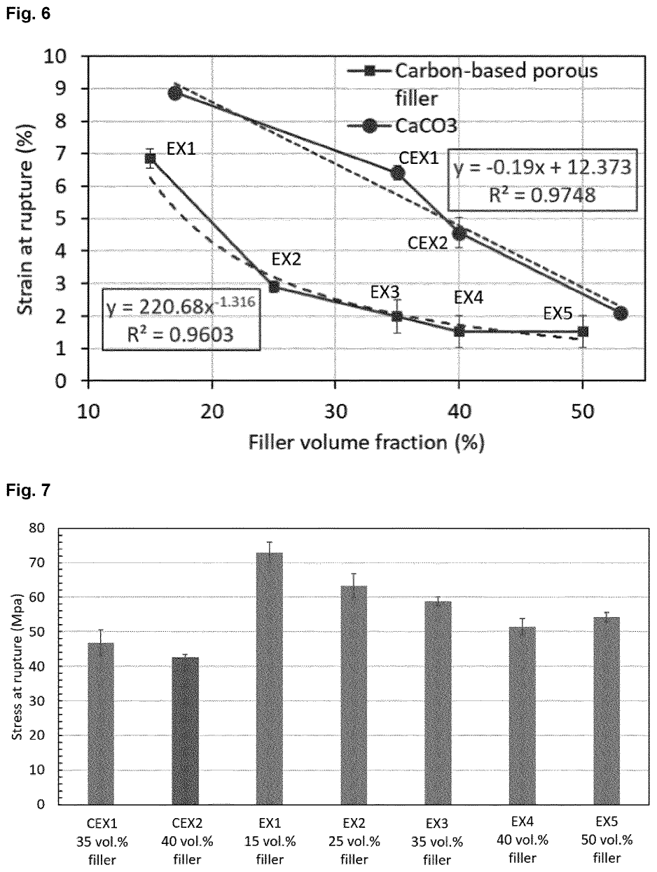

An evaluation of the strain at rupture upon bending loading is presented in FIG. 6 for different volume fractions of carbon-based porous filler and calcium carbonate, respectively. For both thermoplastic materials, the strain at break decreases with increasing content in filler. In the range of studied volume fractions, the carbon-filled thermoplastic materials exhibited lowest stains at break. Nevertheless, the rate of decrease of the strain at break in the porous carbon-filled composites is lower (power-like) than in the calcium-carbonate-filled composite (linear). This is likely due to the better adhesion/interaction between the porous carbon filler and the PVC, which constrains the polymer chain motion to accommodate loading (lower strain at break) but demands larger stress to lead to the rupture.

The ultimate stress values determined by 3-point bending are presented in FIG. 7. Stress at rupture for the CPF-filled thermoplastic materials was higher than for the CaCO₃-filled composites. This suggests that the stress transfer between the CPF and the polymer matrix is better than in standard CaCO₃-filled thermoplastic materials. For a given volume fraction of filler, an improvement of 20% in the ultimate stress was observed for the CPF composites.

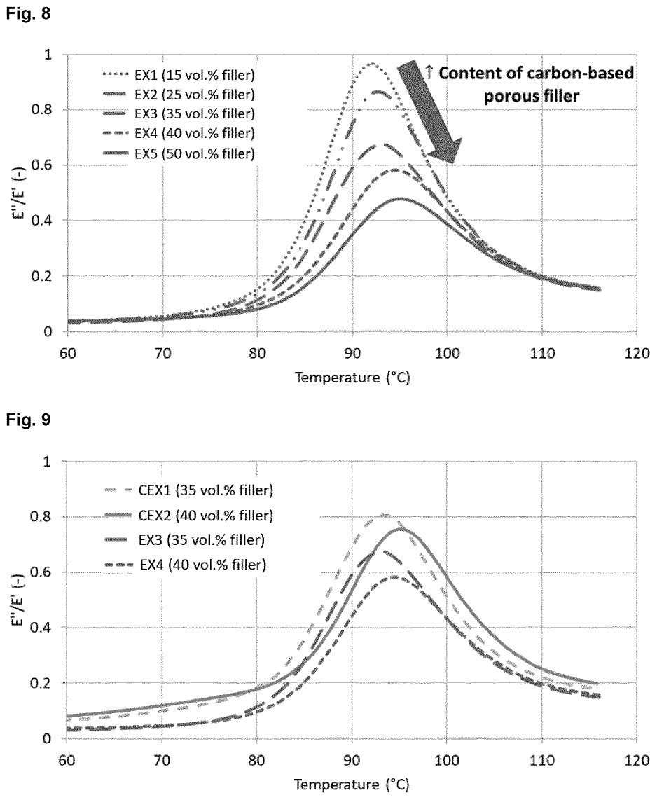

The evolution of the loss factor, i.e., the ratio between the loss modulus, E″, and storage modulus, E′, with the temperature is displayed in FIG. 8 for thermoplastic materials with different content of CFP. This parameter is a direct indicator of the material internal dissipation related to the cooperative polymer chain motions. The higher the E″/E′, the higher is the internal dissipation and thus, the lower is the polymer-filler interaction. When the volume fraction of CPF increases, the amplitude of E″/E′ decreases. This indicates that the polymer chains of PVC are interacting with the CPF filler.

FIG. 9 compares the loss factor as a function of the temperature in thermoplastic materials comprising calcium carbonate or CPF, respectively. When comparing the amplitude of E″/E′ at iso-volume concentration of CPF and CaCO₃, thermoplastic materials with CPF show a 20% lower E″/E′ amplitude. This indicates a better polymer-filler interaction between PVC and CPF than between PVC and CaCO₃.

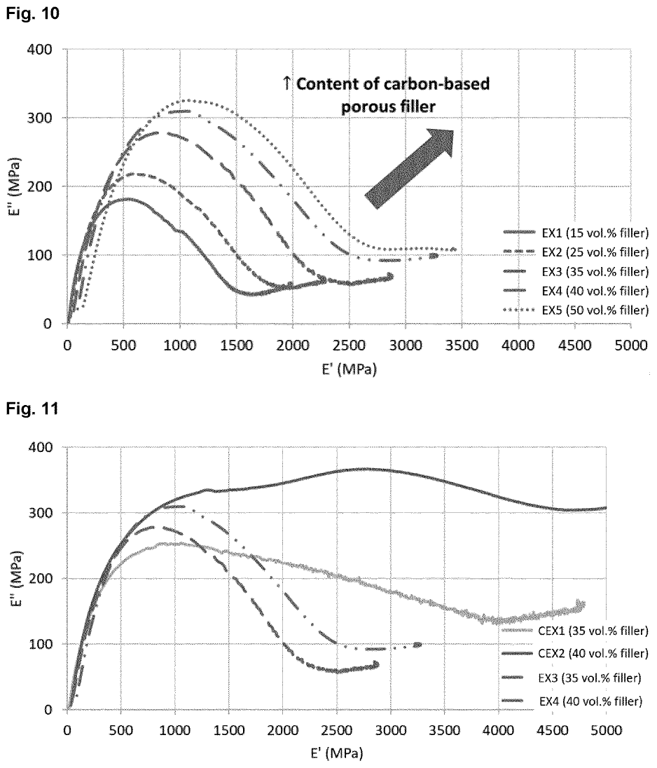

The viscoelastic behaviour of the thermoplastic materials can be further investigated by the Cole-Cole method, according to which the loss modulus is plotted as a function of the storage modulus. This is depicted in FIG. 10. Homogenous composite systems, i.e., with well-distributed and dispersed fillers, exhibit semi-circular Cole-Cole plots. This was the case for the thermoplastic materials of examples EX1-EX5. For the thermoplastic materials of comparative examples CEX1-CEX2 with CaCO₃, the shape of the Cole-Cole plots was imperfect (see FIG. 11), indicating a heterogeneous distribution of the filler. Therefore, under the same processing conditions, CPF filler may be better distributed in the polymer matrix.

The presence of fillers can restrict the polymer chains, providing mechanical reinforcement. The level of entanglements of the polymer composite can serve as an indicator of the level of polymer-filler interaction by adsorption. Using the rubber elasticity theory, the density of entanglements, νₑ, in a polymer system can be determined as follows:

$${v}_{e} = \frac{{E}_{c \_ 120 ° C .} {N}_{A}}{3 R T} \qquad ( Eq . 2 )$$

where E_{c_120° C.}, N_{A}, R and T are the storage modulus of the thermoplastic material in the rubbery plateau, the Avogadro number, the gas constant, and the absolute temperature, respectively.

The mechanical reinforcement efficiency of the fillers, r, can be evaluated using the Einstein equation:

$$r = ( {E}_{c \_ 120 ° C .} / {E}_{m \_ 120 ° C .} - 1 ) / {ϕ}_{f} \qquad ( Eq . 3 )$$

where E_{m_120° C.} is the storage modulus of the polymer in the rubbery plateau.

Table 5 illustrates the effect of the filler content (by volume) on viscoelastic properties. The results are derived from the dynamic mechanical thermal analysis (DMA) carried out on the different samples according to the examples and the comparative examples.

TABLE 5

| | Examples | | | | | | |
|---|---|---|---|---|---|---|---|
| Property | CEX1 | CEX2 | EX1 | EX2 | EX3 | EX4 | EX5 |
| Filler | CaCO₃ | CaCO₃ | CPF1 | CPF1 | CPF1 | CPF1 | CPF1 |
| | 35 vol. % | 40 vol. % | 15 vol. % | 25 vol. % | 35 vol. % | 40 vol. % | 50 vol. % |
| E″/E′ | 0.81 | 0.76 | 0.96 | 0.86 | 0.68 | 0.58 | 0.48 |
| Entanglemets | 0.99 | 1.96 | 0.55 | 0.97 | 2.21 | 4.54 | 7.86 |
| (×10²⁶ mol/m³) | | | | | | | |
| Reinforcing | 6.35 | 13.45 | 5.24 | 8.65 | 17.69 | 34.52 | 49.24 |
| efficiency | | | | | | | |

The density of entanglements and the degree of reinforcement increases with increasing content of filler. The increase is higher when adding CPF. Indeed, when comparing at iso-volume of fillers, the thermoplastic materials with CPF display higher levels of entanglement and reinforcement than the thermoplastic materials with CaCO₃, suggesting a stronger interaction of the thermoplastic polymer with the CPF than with CaCO₃.

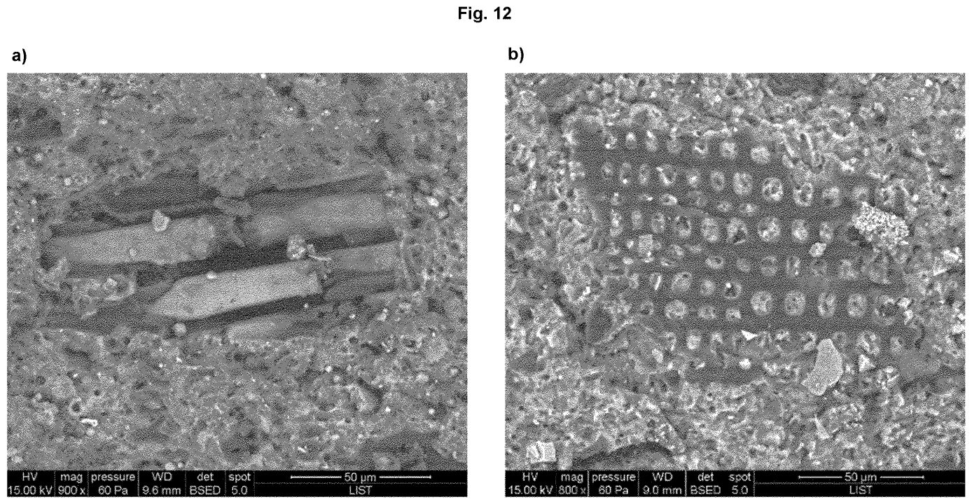

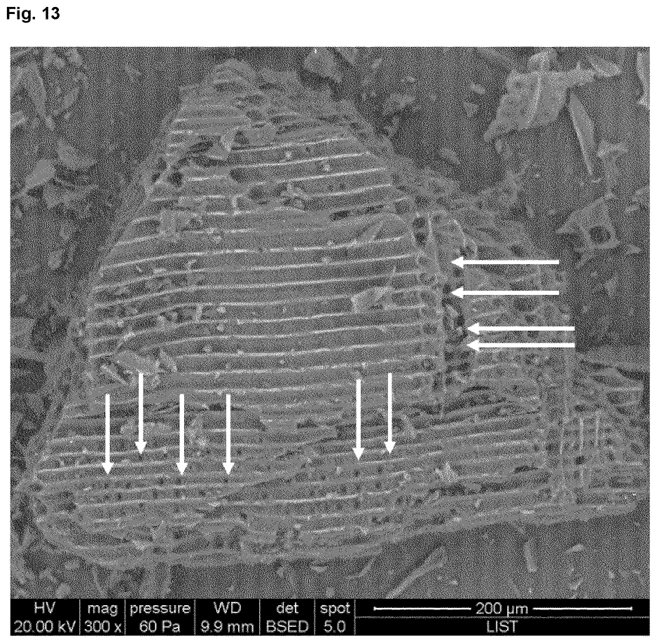

SEM images of the fractured surface of samples with CPF obtained from the 3-point bending test are presented in FIG. 12. The images reveal that the polymer infiltrated the pores of the CPF during the extrusion process, enabling mechanical interlocking.

The above results show that mechanical reinforcement of thermoplastic material with CPF may be the consequence of: i) the stiffness of the filler (related to the carbon content), ii) the mechanical interlocking generated by the polymer filling the filler pores, and iii) the adsorption and surface reaction related to the polymer affinity to the CPF or the functional groups on the CPF surface (measured by FT-IR).

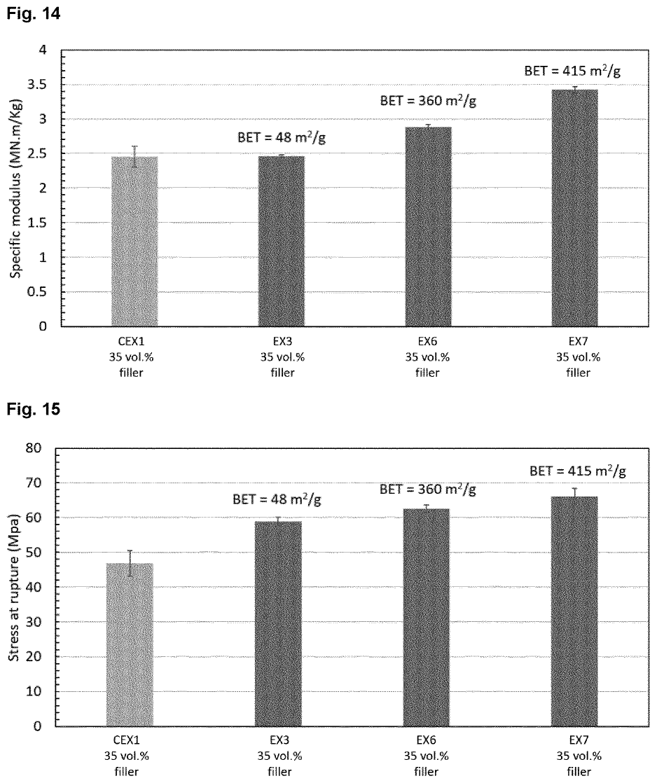

The specific stiffness of thermoplastic materials filled with CPFs of different SSA is depicted in FIG. 14. The diagram shows that the specific stiffness increases with increasing specific surface area. The same trend may be observed for the flexural stress at rupture (FIG. 15). Indeed, the increase in SSA may be related to a higher number of pores that serve as interlocking points between the filler and the polymer, increasing the stress transfer.

Table 6 illustrates the effect of the SSA on viscoelastic properties. The results are derived from the DMA, using equations Eq. 2 and Eq. 3.

TABLE 6

| | Examples | | | |
|---|---|---|---|---|
| | CEX1 | EX3 | EX6 | EX7 |
| | Filler | | | |
| | CaCO₃ | CPF1 | CPF2 | CPF3 |
| Property | (35 vol. %) | (35 vol. %) | (35 vol. %) | (35 vol. %) |
| E″/E′ | 0.81 | 0.68 | 0.67 | 0.67 |
| Entanglements | 0.99 | 2.21 | 2.34 | 2.95 |
| (×10²⁶ mol/m³) | | | | |
| Reinforcing | 6.35 | 17.69 | 18.96 | 24.62 |
| efficiency | | | | |

As can be observed, the amplitude of E″/E′ decreases with the SSA of the fillers, whereas the density of entanglements and the reinforcing efficiency increase. This can be explained by the higher level of interaction that is obtained when increasing the number of pores of the fillers.

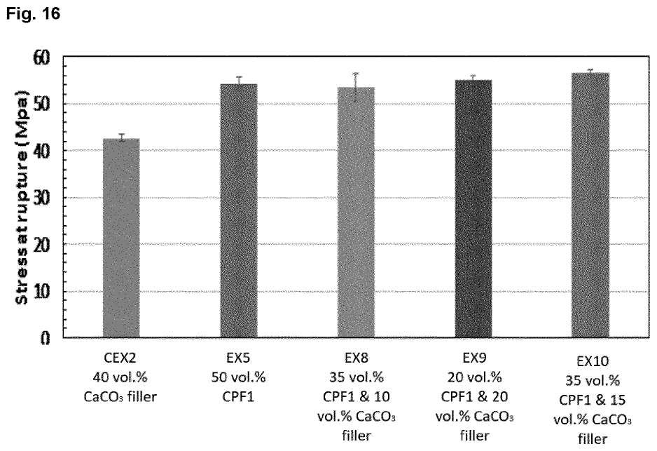

As illustrated in FIG. 16, replacing part of the volume of CaCO₃ filler with CPF may improve the stress at rupture of the thermoplastic composite when compared to a similar thermoplastic composite comprising only CaCO₃ as the filler.

As for PVC thermoplastic composite material, it has been shown in PP thermoplastic composite material according to EX11 that substituting part of the conventional mineral fillers by CPF filler in a PP matrix leads to an improved reinforcement effect with increased stress at break (+25%) compared to the comparative example CEX3. Density is lowered as well in example EX11 compared to comparative example CEX3.

The enhanced mechanical reinforcement provided by CPF may be beneficial in structural layers of decorative surface coverings, such as flooring. Particularly preferred aspects of the disclosure thus relate to the use of CPFs in rigid layers of flooring, such as LVT click products, and flooring tiles comprising one or more core layers of the thermoplastic material containing CPF as described herein. Such core layers could be monolayers (preferably made by extrusion and agglomeration), multilayers (e.g., obtained by coextrusion), compact or foamed. According to a specific embodiment, the core layer is a foamed monolayer. A core layer comprising compact (unfoamed) outer layers sandwiching a foamed inner layer may be a particularly preferred option for flooring tiles, in particular for relatively lightweight, rigid LVT products with interconnection profiles along the lateral edges.

Flooring tiles with connecting profiles in accordance with different embodiments of the disclosure showed good fatigue properties in the Castor chair test (ISO 4918:2016 as amended in 2018). The results indicated that there would be a possibility to decrease the thickness of the core layer of flooring components by roughly 10% when compared with flooring tiles currently on the market.

Decorative surface coverings in accordance with the disclosure may thus have a significantly reduced ecological impact (in particular a significantly reduced CO₂ footprint) compared to standard surface coverings comprising only traditional fillers like CaCO₃. Furthermore, as has been shown by the inventors, the use of CPF with particular physicochemical properties leads to improved mechanical properties, so that the thickness of decorative floor coverings may be reduced, resulting in an additional reduction of the ecological impact.

While specific embodiments have been described herein in detail, those skilled in the art will appreciate that various modifications and alternatives to those details could be developed in light of the overall teachings of the disclosure. Accordingly, the particular arrangements disclosed are meant to be illustrative only and not limiting as to the scope of the disclosure, which is to be given the full breadth of the appended claims and any and all equivalents thereof.

1. A decorative surface covering, e.g., a floor covering, a wallcovering or a ceiling covering, comprising a core layer, wherein the core layer comprises a thermoplastic material including one or more thermoplastic polymers as a matrix and a carbon-based porous filler (CPF) dispersed in the matrix, wherein the CPF has a carbon content of at least 70% of the dry weight and a specific surface area of 5 to 500 m²/g, measured in accordance with standard ISO 9277:2010 (Brunauer-Emmett-Teller (BET) method).

2. The decorative surface covering as claimed in claim 1, wherein the CPF has an isotopic ratio ¹⁴C/¹²C of at least 10-12.

3. The decorative surface covering as claimed in claim 1, wherein the CPF comprises biochar.

4. The decorative surface covering as claimed in claim 1, wherein the thermoplastic material comprises dispersed therein, an additional filler selected among: ground limestone, dolomite, calcium carbonate, zeolite, magnesium carbonate, chalk, phyllosilicate, glass particles, and aluminium trihydroxide.

5. The decorative surface covering as claimed in claim 1, wherein the thermoplastic material comprises from 2 to 70% by weight, of the CPF.

6. The decorative surface covering as claimed in claim 1, wherein the thermoplastic material has an overall filler content from 5 to 70% by weight.

7. The decorative surface covering as claimed in claim 1, wherein the CPF has a D50 diameter in the range from 1 μm to 50000 μm.

8. The decorative surface covering as claimed in claim 1, wherein the CPF comprises particles anchored in the thermoplastic polymer matrix by mechanical interlocking caused by thermoplastic polymer penetrated into pores of the particles.

9. The decorative surface covering as claimed in claim 1, wherein the CPF comprises particles with multidirectional porosity, with first pores extending in a first direction and second pores extending in a second, transversal, direction.

10. The decorative surface covering as claimed in claim 8, wherein the CPF has pores with pore diameters in the range from 0.5 μm to 30 μm.

11. The decorative surface covering as claimed in claim 1, the decorative surface covering comprising a surface covering tile comprising a décor layer, a wear layer, and, optionally, a backing layer.

12. The decorative surface covering as claimed in claim 11, wherein the décor layer comprises a printing substrate carrying a print, the printing substrate having hiding power H₁₀ of at least 80%, measured in accordance with standard ISO 6504-3:2019.

13. The decorative surface covering as claimed in claim 1, wherein the core layer is a stiff core layer possessing a deformation angle of less than 7 degrees, as measured at 23° C. for a rectangular core layer sample with dimensions of 160 mm×450 mm, clamped in a horizontal cantilevered position so as to obtain a 160×300 mm projecting part of the sample, the deformation angle being measured 30 seconds after removal of a support that prevents a deformation of the projecting part under the influence of its own weight.

14. The decorative surface covering as claimed in claim 1, the decorative surface covering comprising a flooring tile, the flooring tile comprising a first locking connector along a first edge, a second locking connector along a second edge, the first and second locking connectors being complementarily profiled, so that the flooring tile can be interlocked with another flooring tile by engaging the first or the second locking connector of the flooring tile with the second or first locking connector of the other flooring tile.

15. The decorative surface covering as claimed in claim 1, wherein the one or more thermoplastic polymers include polyvinyl chloride, polypropylene, or polyvinyl butyral, or recycled polyvinyl chloride, or recycled polyvinyl butyral.

16. The decorative surface covering as claimed in claim 1, wherein the core layer comprises a core layer assembly including at least two layers of different constitutions.

17. The decorative surface covering as claimed in claim 16, wherein the core layer assembly includes three or more layers, including two outer layers sandwiching one or more inner layers.

18. The decorative surface covering as claimed in claim 17, wherein the two outer layers are unfoamed layers comprised of the thermoplastic material.

19. The decorative surface covering as claimed in claim 17, wherein the one or more inner layers comprise at least one foamed layer, the foamed layer optionally comprising the thermoplastic material or another thermoplastic material including one or more thermoplastic polymers as a matrix and a carbon-based porous filler (CPF) dispersed in the matrix, the CPF having a carbon content of at least 70%, of the dry weight and a specific surface area of 5 to 500 m²/g measured in accordance with standard ISO 9277:2010 (Brunauer-Emmett-Teller (BET) method).

20. (canceled)

21. (canceled)

22. A process for manufacturing a core layer of the decorative surface covering as claimed in claim 1, comprising the steps:
1) mixing a thermoplastic material including one or more thermoplastic polymers and a carbon-based porous filler (CPF) at a peripherical speed from 5 m·s⁻¹ to 85 m·s⁻¹ until the mixture of thermoplastic material and carbon-based porous filler (CPF) reaches a temperature from 95° C. to 125° C., and
2) extruding the mixture of thermoplastic material and carbon-based porous filler (CPF) at a temperature of at least 100° C. by using at least one screw that rotates at a local maximum shear rate from 50 s⁻¹ to 400 s⁻¹.
